(19) United States
(12) Patent Application Publication
(10) Pub. No.: US 2005/0218011 A1
(43) Pub. Date: Oct. 6, 2005

(54) Paintbox for watercolors

(76) Inventor: Jim Dewitt, Richmond, CA (US)

Correspondence Address: DAVID S. DOLBERG, 37 TERRACE AVE., RICHMOND, CA, 94801, US

(21) Appl. No.: 10/818,984

(22) Filed: Apr. 6, 2004

(51) Int. Cl. B05C 17/00

(52) U.S. Cl. 206/1.7; 206/205

(57) ABSTRACT

An artist's paint box and palette is disclosed which allows water based paints to be used and stored wet. Each paint is kept in a ceramic cup which is kept in a water reservoir such that the cup wicks the moisture from the reservoir. A snuggly fitting lid keeps the stored paints in a well humidified atmosphere.

### FIELD OF THE INVENTION

This invention relates generally to artist's paint trays, palettes and paint boxes. More specifically, it relates to a device for maintaining water-based paints in a functionally hydrated and workable condition during both storage and use.

### BACKGROUND OF THE INVENTION

Water based paints tend to dry out when exposed to the atmosphere. This situation is exacerbated by conditions of low humidity, high temperature, and long exposure. Many types of water-based paints are known and all are subject to the same general limitations of use. Examples include water colors, tempera, distemper, gouache and aquarelle. A typical solution is to use dry pigment, hydrating only at the time of use. Another solution is to use tubes of hydrated ready-to-use paints; however once exposed to air, the paints must be used quickly or kept fully hydrated or else they will become useless.

Watercolorists are faced with the challenge of keeping their paints fully moistened and hydrated during use and storage. Several attempts have been made to provide an apparatus that keeps water-based paints hydrated, but each has its drawbacks and limitations. McIntosh (U.S. Pat. No. 4,901,850) teaches an artists palette that provides air-tight storage for any painting medium, however the effectiveness of the device is negligible when the lid is open. Ford (U.S. Pat. No. 4,638,909) teaches a container for retaining artists' paints and preventing them from drying by providing a box and a lid with a gasket, but suffers from the same deficiency as McIntosh. Similarly, Crawford (U.S. Pat. No. 3,786,913) teaches an artist's paint box which utilizes a sponge as a water reservoir, but with the same limitation.

Tanaka (U.S. Pat. No. 4,180,159) teaches a tray assembly for maintaining paint with a moisture content which wicks water from a reservoir to each paint well, however, the port which provides entry of the wick to the well is a source of potential leakage and the paint in the well is subject to a hydrating gradient radiating out from the wick port. Rubel (U.S. Pat. No. 3,885,843) teaches a dual purpose humidifier for palettes containing air drying paints which also uses a wick.

Finally, Barnett (U.S. Pat. No. 3,874,499) teaches an artist's palette which utilizes a water permeable palette base which must be used in conjunction with a disposable palette liner, and lacks the ability to separately store different paints.

### SUMMARY OF THE INVENTION

The instant invention describes an artist's paint box comprising a base with a palette. The base is adapted to hold multiple removable paint cups, or alternatively, a paint trough with multiple compartments, and also includes a water reservoir below the cups which keeps water in contact with the cups. The paint cups are porous, generally fabricated from ceramic material, and sit in contact with the water in the reservoir. A lid is provided which snuggly fits over the base during storage. Water in the reservoir is in constant contact with the cups and consequently water is wicked into and permeates the cups. Water-based paints are kept within each cup for both use and storage. Paint from the cups may be mixed on the palette during use. Between uses placement of the lid on the base keeps paint in the cups and on the palette in a hydrating atmosphere.

It is an object of the present invention to provide an artist's paint box for the storage and use of water-based paints while maintaining hydration.

It is an object of the present invention to provide an artist's paint box and mixing palette that prevents dehydration of water-based paints.

It is an object of the present invention to provide an artist's paint box with multiple, removable and replaceable paint reservoirs.

It is an object of the present invention to provide a multi-reservoir artist's paint box which prevents the formation of a hydration gradient within each paint reservoir.

It is an object of the present invention to provide water permeated cups for the storage and open air use of water-based paints.

In accordance with the above objectives and other described herein, a device for maintaining the hydration of multiple aqueous-based paint reservoirs is provided which comprises a base adapted to receive a multiplicity of removable porous cups. The device further comprises a multiplicity of cups each for holding a quantity of aqueous-based paint and each having an inside and outside surface. The device further comprises a water-containing reservoir within the base adapted to stably hold the cups with the outer surfaces of the cups in contact with the reservoir water. Finally, the device comprises a removable lid adapted to snuggly fit over the reservoir and cups thereby providing a humidifying atmosphere within the space created by the lid and the base.

### DESCRIPTION OF THE DRAWINGS

FIG. 1 is an expanded perspective view of an embodiment of the invention.

FIG. 2 is a top view of the palette and paint cups of the invention.

FIG. 3 is a top view of a paint trough divided into paint cups.

FIG. 4 is a perspective view of a paint trough.

FIG. 5 is an end view of a cut through a trough.

### DETAILED DESCRIPTION OF THE INVENTION

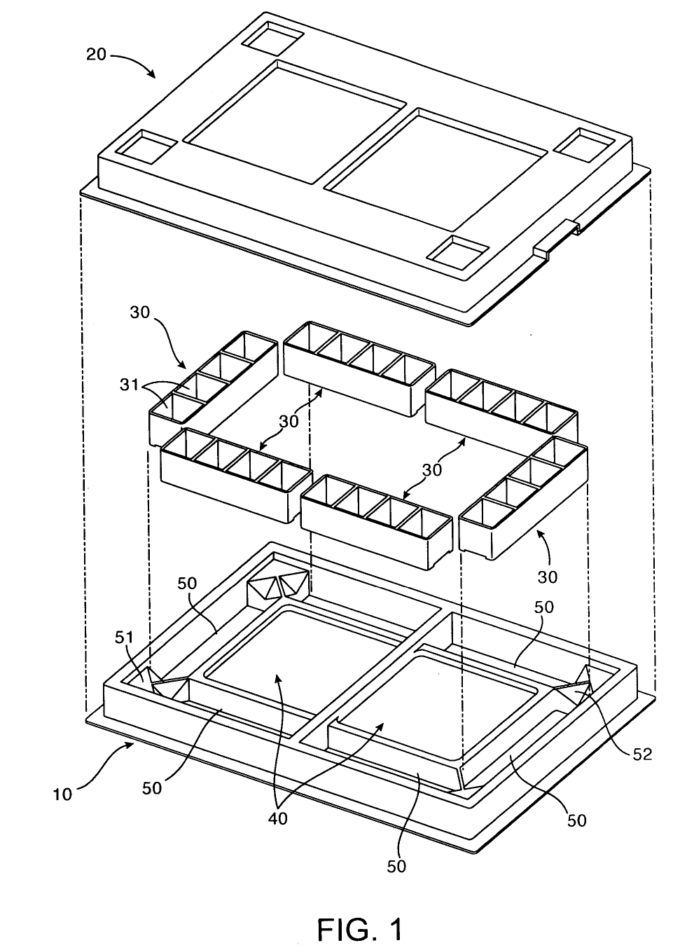

Reference is made to FIG. 1. The instant invention discloses an artist's paint box comprising a base (10) with a snuggly fitting lid (20). In a preferred embodiment, the base and lid are fabricated from a stiff plastic material impervious to water, such as PVC. The base and lid are preferably formed by thermal molding on a form. In a preferred embodiment, PVC sheet material of 1 to 2 mm thickness is used. A mold is used to provide the desired shape. The mold is placed in heat/vacuum molding apparatus known in the art. Electric heating is preferred. After vacuum shaping, the rough product is moved onto a trimming and cutting machine. Edges are cut according to the trimming mold.

The product can also be fabricated by injection molding, a method well known in the art. Alternatively, the base and lid can be made from a non-rusting metal such as aluminum or stainless steel.

The lid fits snuggly on the base. In a preferred embodiment, the lid is held in place on the base by a friction fit. However, additional fastening devices well know in the art, such as but not limited to snaps, buckles or bands, can be added.

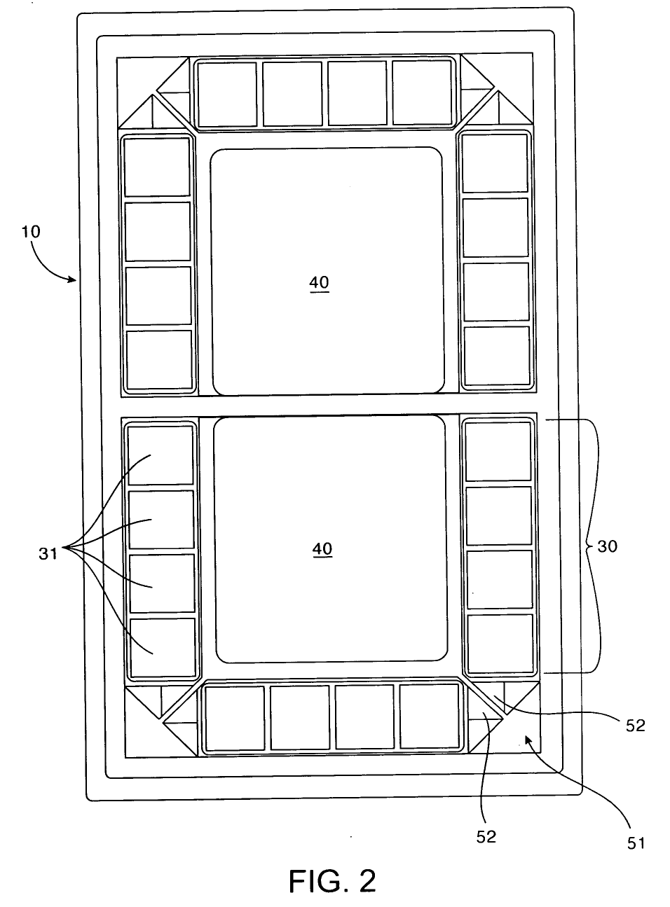

As shown in FIGS. 1 and 2, the perimeter of the interior of the base is adapted to receive one or more removable paint cups (31). In a preferred embodiment, the cups are organized into one or more troughs (30). In the example shown in the figures, 6 removable troughs (30), each with 4 cups (31), are provided. The adaptations of the base which receive the troughs are deep enough such that the troughs sit securely within the base. Each cup is intended to hold a mixed paint of pigment and water solvent during use and to store the mixed paint between uses.

In a preferred embodiment at least one palette (40) is incorporated into the base design. In the example shown in the figures, two separate palettes are provided. The palettes are used to mix different colors during a paint session and can then be wiped clean.

Water Reservior

An essential feature of the instant invention is the reservoir capacity (50) incorporated into the base. The reservoir (50) may be singular or multiple. As shown in FIGS. 1 and 2, each trough (30) has a distinct reservoir (50). A feature of the embodiment shown in the figures is the corners (51) of the base (10) formed at each of the intersections of the perimeter troughs (30). A portion of each corner is recessed (52). This allows for monitoring of water in the reservoir while the trough is in place and also allows for each filling and refilling of the reservoir while the tough is in place. The reservoir volume is best kept to a minimum in order to minimize the possibility of spilling water during movement or transport of the tray. This is accomplished by sizing the reservoir (50) to fit the trough (30) and minimizing the effective volume of the corners (51) by diagonally slanting the corner walls (52).

As described here and below, when the reservoir is filled with the water, outer bottom side of the cups and troughs are in constant contact with the water and water permeates the porous cups and troughs.

This insures that water soluble, aqueous based paints placed in each cup will not dry out even when exposed to the air during use. During storage, the snugly fitting lid (20) minimizes air circulation and creates a humidified atmosphere over the hydrated paints, troughs and palette.

Cups and Troughs

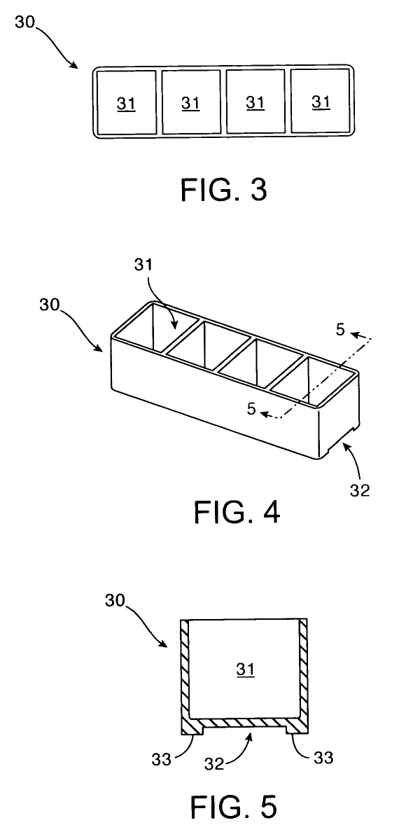

Another essential feature of the instant invention is the cups (31) and troughs (30). Each cup (31) is intended to hold a different color paint. For convenience as shown in FIGS. 3 and 4, the cups can be incorporated into and organized within a rectangular trough (30). Each trough consists of multiple cup compartments (31).

Attention is now directed to FIG. 5. In a preferred embodiment, the central portion (32) of the bottom of the trough (30) is raised slightly to increase slightly the amount of water underneath the trough. This water is prevented from spilling out by the rails (33) along the long edges of the bottom of the trough (30) by creation of the central indentation (32). Each cup is intended to hold a pigment dissolved in water during use and between uses. The trough and cups can be removed from the tray, washed out and reused.

A cup, or trough of cups, is fabricated as a ceramic unit. Ceramic is the preferred material, however it will be appreciated that any water permeable material can be used. Examples of other materials are cardboard, fritted glass, wood, and the like. In a preferred embodiment, the exterior dimensions of the ceramic pieces are approximately 150 cm long, 40 cm wide and 20 cm deep. The interior dimensions of each cup are 30 cm square and 15 cm deep. The pieces are made using clay mixed with water. The pieces are then shaped. Alternatively, a mold could be used to obtain the desired shape. The pieces are then allowed to air dry and then placed in a kiln and heated step wise up to 1000 degrees Centigrade. The pieces are then allowed to cool in the kiln for 4 hours down to a temperature of 600 degrees Centigrade. Then kiln is then opened and the pieces are allowed to continue to cool to room temperature. This method provides the desired porosity of the pieces. Other conditions might be used so long as equivalent porosity of the pieces is provided.

### EXAMPLES

The embodiment illustrated in FIGS. 1 and 2 show the following features. This embodiment has two distinct palettes and 6 troughs, each trough having 4 cups. In another preferred embodiment, the tray is square instead of rectangular. It has only one palette and each of the four sides holds one trough. It is essentially the halved version of the embodiment in the illustration. For manufacturing purposes, the dimensions of the one palette and two palette versions are scaled so that identically dimensioned ceramic troughs can be used for both.

In the foregoing, the present invention has been described with reference to suitable embodiments, but these embodiments are only for purposes of understanding the invention and various alterations or modifications are possible so long as the present invention does not deviate from the claims that follow.

1. A device for maintaining a multiplicity of hydrated paint mixtures comprising:
a. one or more removable porous cups each for holding a quantity of aqueous based paint, said cups having an inside and an outside surface:
b. a base comprising a water containing reservoir, said base adapted to receive and stably hold said cups such that the outside surface of the cup contacts water in the reservoir,
c. a removable lid adapted to fit snugly over the base and retaining a humidified atmosphere thereby.

2. The device of claim 1 wherein the cups are organized within one or more troughs.

3. The device of claim 1 wherein the cups are ceramic.

4. The device of claim 1 with multiple cups.

5. The device of claim 2 with multiple troughs.

6. The device of claim 4 wherein said base additionally comprises a palette for mixing paints.
